(19) United States
(12) Patent Application Publication
(10) Pub. No.: US 2018/0307161 A1
(43) Pub. Date: Oct. 25, 2018

(54) DEVELOPER CONVEYING MECHANISM, AND DEVELOPING DEVICE AND IMAGE FORMING APPARATUS THEREWITH

(71) Applicant: KYOCERA Document Solutions Inc., Osaka (JP)

(72) Inventors: Hirofumi TSUJI, Osaka (JP); Yoshitaka TOKORO, Osaka (JP)

(73) Assignee: KYOCERA Document Solutions Inc., Osaka (JP)

(21) Appl. No.: 15/935,791

(22) Filed: Mar. 26, 2018

(30) Foreign Application Priority Data
Apr. 19, 2017 (JP) 2017-082530

(51) Int. Cl. G03G 15/08

(52) U.S. Cl. CPC G03G 15/0891; G03G 15/0886

(57) ABSTRACT

A developer conveying mechanism has a pipe-shaped conveyance passage, a shutter, a sealing member, and a biasing member. Through the pipe-shaped conveyance passage, developer is conveyed, and a discharge port is formed in a part of a side surface of the pipe-shaped conveyance passage. The shutter is arranged to be slidable along the outer circumferential surface of the pipe-shaped conveyance passage, and opens and closes the discharge port. The sealing member is fixed to the inner circumferential surface of the shutter. The biasing member biases the shutter in a direction in which the discharge port is closed. The sealing member has a frame-shaped contact portion making contact with the pipe-shaped conveyance passage, and a non-contact portion in the contact portion.

### INCORPORATION BY REFERENCE

This application is based upon and claims the benefit of priority from the corresponding Japanese Patent Application No. 2017-082530 filed on Apr. 19, 2017, the entire contents of which are incorporated herein by reference.

### BACKGROUND

The present disclosure relates to a developer conveying mechanism incorporated in an image forming apparatus such a copier, a printer, a facsimile machine, or a multifunction peripheral having their functions integrated together. More particularly, the present disclosure relates to a mechanism that opens and closes a developer discharge port formed in a passage through which developer is conveyed.

Conventionally, in developing devices adopting a two-component developing system, to prevent degradation in charging performance of carrier, a developing device has been proposed that supplies new developer containing carrier into a developer container and that incorporates a developer discharge portion which discharges surplus developer. In this developing device, it is necessary to prevent, at an initial stage of driving, occurrence of damage resulting from friction between members such as a developing roller and the like; thus, an amount of developer sufficient to form a toner layer on the developing roller is previously stored. Thus, when the developing device, after having been mounted in an image forming apparatus main body or after having been packed separately from the image forming apparatus main body, is transported, due to shaking and an impact occurring during transportation, the developer stored in the developing device may leak out of the developer discharge portion, splash, and contaminate the inside of the image forming apparatus.

As a solution, it is common to fit a developer discharge portion in a developing device with a shutter which covers a discharge port so that, when the image forming apparatus is set up, the developing device is, with the shutter of the discharge port open, mounted in the image forming apparatus main body, or the shutter of the developing device is opened after the developing device has been mounted in the image forming apparatus main body.

Incidentally, when an image forming apparatus is transported with a developing device mounted in it in which a discharge port is left open and closed by a shutter, due to shaking and an impact occurring during the transportation, developer may leak out through between the outer circumferential surface of the developer discharge portion and the inner surface of the shutter. To prevent leakage of developer, a sealing member is preferably provided between the outer circumferential surface of the developer discharge portion and the inner surface of the shutter. However, if the sliding load between the shutter and the sealing member increases, the shutter does not function properly and cannot completely close the discharge port, with the result that, inconveniently, developer leaks out through the discharge port. On the other hand, if the sliding area between the sealing member and the shutter is reduced, while the sliding load is reduced, the sealing effect is inconveniently reduced.

As a solution, there has been proposed a method for achieving a smooth opening and closing of the shutter while maintaining the sealing effect. For example, in a known developer conveying mechanism in which a sealing member is arranged between a pipe-shaped passage and a shutter, the sealing member is fixed to the outer circumferential surface of a pipe-shaped conveyance passage, the sealing member has formed in it an opening overlapping a discharge port, and the sealing member has an inclined portion such that its dimension in a width direction orthogonal to the moving direction of the shutter decreases from upstream to downstream relative to the closing direction of the shutter.

### SUMMARY

According to one aspect of the present disclosure, a developer conveying mechanism includes a pipe-shaped conveyance passage, a shutter, a sealing member, and a biasing member. Through the pipe-shaped conveyance passage, developer is conveyed, and a discharge port is formed in a part of a side surface of the pipe-shaped conveyance passage. The shutter is arranged so as to be slidable along the outer circumferential surface of the pipe-shaped conveyance passage, and opens and closes the discharge port. The sealing member is fixed to the inner circumferential surface of the shutter. The biasing member biases the shutter in a direction in which the discharge port is closed. The sealing member has a contact portion which makes contact with the outer circumferential surface of the pipe-shaped conveyance passage so as to surround the discharge port in a state where the discharge port is closed by the shutter, and a non-contact portion in the contact portion.

Further features and advantages of the present disclosure will become apparent from the description of embodiments given below.

### BRIEF DESCRIPTION OF THE DRAWINGS

FIG. 1 is a schematic diagram showing an overall construction of a color printer;

FIG. 2 is a side sectional view of a developing device incorporated in the color printer;

FIG. 3 is a sectional plan view of a stirring portion in the developing device;

FIG. 4 is an enlarged view around the developer discharge portion in FIG. 3;

FIG. 5 is a partial perspective view showing a state with a front surface-side outer cover of the color printer open;

FIG. 6 is a perspective view showing a state with the inner cover in FIG. 5 removed to expose a developer collecting mechanism;

FIG. 7 is a side sectional view of the developer collecting mechanism, showing a state with a discharge port closed by a shutter;

FIG. 8 is a side sectional view of the developer collecting mechanism, showing a state with the discharge port left open by the shutter;

FIG. 9 is an exploded perspective view of the developer discharge portion in the developing device;

FIG. 10 is a plan view of the developer discharge portion in FIG. 9 as seen from the discharge port side;

FIG. 11 is a side sectional view of the developer discharge port, showing a state where the discharge port is closed by the shutter;

FIG. 12 is a side sectional view of the developer discharge port, showing a state where the discharge port is left open by the shutter;

FIG. 13 is a plan view of an example of an opening formed in a rhombic shape in a sealing member;

FIG. 14A is a plan view showing an example of a concavity formed in a sealing member; and

FIG. 14B is a side view showing an example of the concavity formed in the sealing member.

### DETAILED DESCRIPTION

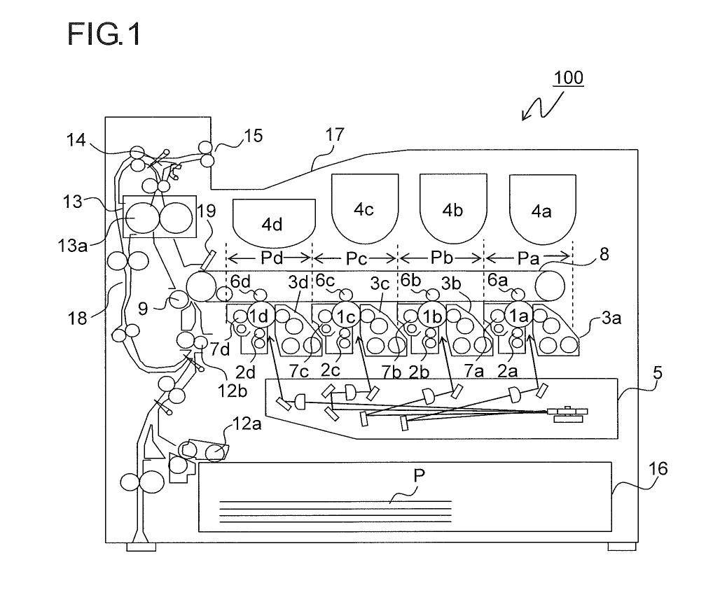

Hereinafter, an embodiment of the present disclosure will be described with reference to the accompanying drawings. FIG. 1 is a schematic sectional view of an image forming apparatus according to the present disclosure, here showing a tandem-type color printer. In the main body of the color printer 100, four image forming portions Pa, Pb, Pc, and Pd are arranged in this order from the upstream side in the conveyance direction (the right side in FIG. 1). These image forming portions Pa to Pd are provided to correspond to images of four different colors (cyan, magenta, yellow, and black) respectively, and sequentially form cyan, magenta, yellow, and black images respectively, each through the processes of electrostatic charging, exposure to light, image development, and image transfer.

In these image forming portions Pa to Pd, there are respectively arranged photosensitive drums 1a, 1b, 1c and 1d that carry visible images (toner images) of the different colors. Moreover, an intermediate transfer belt 8 that rotates in the clockwise direction in FIG. 1 is arranged next to the image forming portions Pa to Pd.

When image data is fed in from a host device such as a personal computer, first, by charging devices 2a to 2d, the surfaces of the photosensitive drums 1a to 1d are electrostatically charged uniformly. Then, through irradiation by an exposing device 5 with light based on the image data, electrostatic latent images based on the image data are formed on the photosensitive drums 1a to 1d respectively. Developing devices 3a to 3d are charged with predetermined amounts of two-component developer (hereinafter, also referred to simply as developer) containing toner of different colors, namely cyan, magenta, yellow, and black respectively, from toner containers 4a to 4d. The toner contained in the developer is fed from the developing devices 3a to 3d to the photosensitive drums 1a to 1d, and electrostatically attaches to them. Thereby, toner images are formed based on the electrostatic latent images formed by exposure to light from the exposing device 5.

Then, an electric field is applied, by primary transfer rollers 6a to 6d, between the primary transfer rollers 6a to 6d and the photosensitive drums 1a to 1d with a predetermined transfer voltage. Thereby, the cyan, magenta, yellow, and black toner images on the photosensitive drums 1a to 1d are primarily transferred to the intermediate transfer belt 8. Toner and the like that remain on the surfaces of the photosensitive drums 1a to 1 d after primary transfer are removed by cleaning devices 7a to 7d.

Transfer sheets P to which toner images are to be transferred are stored in a sheet cassette 16 arranged in a lower part inside the color printer 100. A transfer sheet P is conveyed, via a sheet feeding roller 12a and a registration roller pair 12b, with predetermined timing, to a nip (secondary transfer nip) between a secondary transfer roller 9, which is arranged next to the intermediate transfer belt 8, and the intermediate transfer belt 8. The transfer sheet P having the toner images secondarily transferred to it is conveyed to a fixing portion 13. On the downstream side of the secondary transfer roller 9, a blade-shaped belt cleaner 19 is arranged for removing toner left unused on the surface of the intermediate transfer belt 8.

The transfer sheet P conveyed to the fixing portion 13 is then heated and pressed there by a fixing roller pair 13a so that the toner images are fixed to the surface of the transfer sheet P to form a predetermined full-color image. The transfer sheet P having the full-color image formed on it is discharged as it is (or after being distributed by a branching portion 14 into a reverse conveyance passage 18 and having images formed on both sides of it) onto a discharge tray 17 via a discharge roller pair 15.

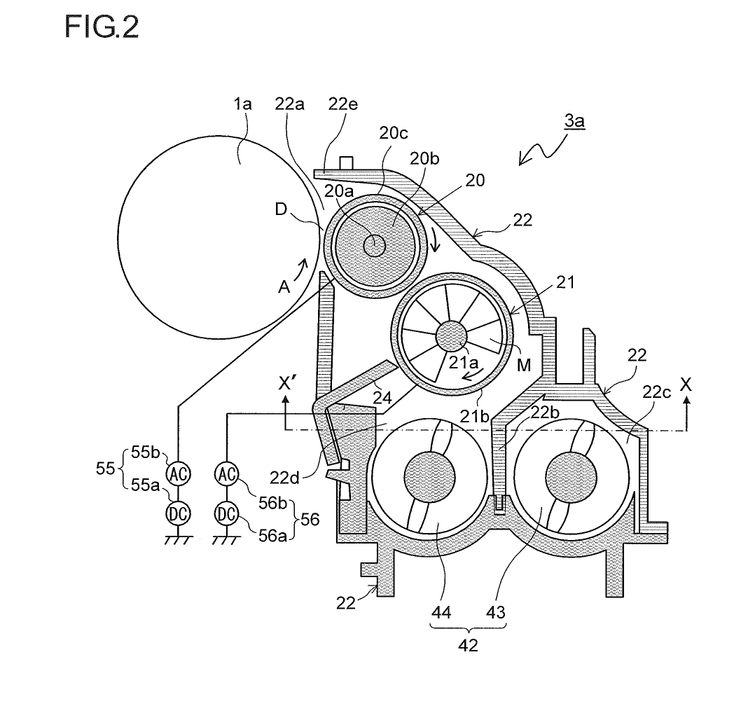

FIG. 2 is a side sectional view showing a structure of the developing device 3a having a developer conveying mechanism according to the present disclosure which is used in the above-described color printer 100. Although, with reference to FIG. 2, the following description deals with the structure and operation of the developing device 3a corresponding to the photosensitive drum 1a shown in FIG. 1, the structure and operation of the developing devices 3b to 3d are similar to those of the developing device 3a, and thus no overlapping description will be repeated.

As shown in FIG. 2, the developing device 3a includes a developing roller 20, a magnetic roller 21, a regulating blade 24, a stirring-conveying member 42, a developer container 22, and the like.

The developer container 22 is divided into a first conveyance chamber 22c and a second conveyance chamber 22d by a partition 22b. In the first conveyance chamber 22c and the second conveyance chamber 22d, two-component developer containing carrier and toner is stored. The developer container 22 rotatably holds the stirring-conveying member 42, the magnetic roller 21, and the developing roller 20. In the developer container 22, there is formed an opening 22a through which the developing roller 20 is exposed toward the photosensitive drum 1a.

The developing roller 20 is composed of a fixed shaft 20a, a magnetic pole member 20b, a developing sleeve 20c formed of a non-magnetic metal material in a cylindrical shape. The developing roller 20 is arranged opposite the photosensitive drum 1a across a predetermined distance, on the right side of the photosensitive drum 1a. The developing roller 20 forms, at a position opposite and close to the photosensitive drum 1a, a developing region D where toner is fed to the photosensitive drum 1a.

The fixed shaft 20a is non-rotatably supported on the developer container 22. Around the fixed shaft 20a, the developing sleeve 20c is rotatably held, and to the fixed shaft 20a, the magnetic pole member 20b comprising a magnet is fixed at a position opposite the magnetic roller 21, at a predetermined distance from the developing sleeve 20c. The developing sleeve 20c rotates in the direction indicated by an arrow in FIG. 2 (the clockwise direction) by the action of an unillustrated driving mechanism. To the developing sleeve 20c, a developing voltage power supply 55 including a DC power supply 55a and an AC power supply 55b is connected and a developing bias having an AC voltage superimposed on a DC voltage is applied.

The magnetic roller 21 is composed of a roller shaft 21a, a magnetic pole member M, and a non-magnetic sleeve 21b formed of a non-magnetic material. The magnetic roller 21 carries on it the developer fed from the stirring-conveying member 42, and feeds, out of the developer, the toner alone to the developing roller 20. The magnetic pole member M has a plurality of magnets, which are each formed to have a fan-shaped section and which have on their peripheral parts different magnetic polarities from one to the next, arranged alternately. The magnetic pole member M is fixed to the roller shaft 21a, which is un-rotatably supported on the developer container 22.

The non-magnetic sleeve 21b rotates in the same direction (the clockwise direction in FIG. 2) as the developing roller 20 by the action of an unillustrated driving mechanism. To the non-magnetic sleeve 21b, a supply voltage power supply 56 including a DC power supply 56a and an AC power supply 56b is connected and a supply bias having an AC voltage superimposed on a DC voltage is applied. On the surface of the non-magnetic sleeve 21b, the charged developer is carried in the form of a magnetic brush by the magnetic force of the magnetic pole member M, and the magnetic brush is adjusted to have a predetermined height (thickness) by the regulating blade 24.

The stirring-conveying member 42 is arranged substantially under the magnetic roller 21. The stirring-conveying member 42 is composed of two spirals, namely a first spiral 43 and a second spiral 44. The second spiral 44 is arranged under the magnetic roller 21, in the second conveyance chamber 22d. The first spiral 43 is arranged next to the second spiral 44, on the right side of it, in the first conveyance chamber 22c. The first and second spirals 43 and 44, while stirring developer, electrostatically charge the toner contained in the developer up to a predetermined level.

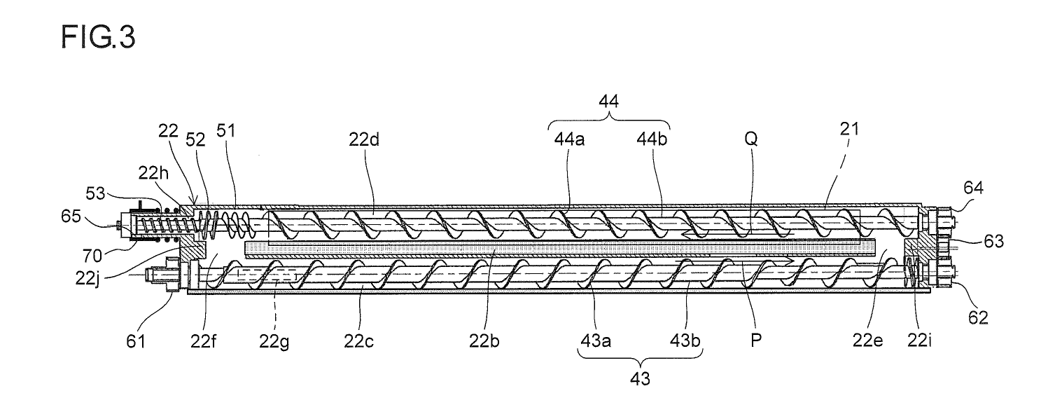

Communication portions (see FIG. 3) are provided in opposite longitudinal-direction (the direction perpendicular to the plane of FIG. 2) end parts of the partition 22b which separates the first conveyance chamber 22c and the second conveyance chamber 22d. As the first spiral 43 rotates, the charged developer is conveyed to the second spiral 44 via one of the communication portions provided in the partition 22b, so that the developer circulates through the first conveyance chamber 22c and the second conveyance chamber 22d. Then, the developer is fed from the second spiral 44 to the magnetic roller 21.

As the non-magnetic sleeve 21b rotates, the magnetic brush is conveyed while being carried on the surface of the non-magnetic sleeve 21b by the magnetic pole member M. When the magnetic brush makes contact with the developing roller 20, the toner alone out of the magnetic brush is fed to the developing roller 20 according to the supply bias applied to the non-magnetic sleeve 21b.

As the developing sleeve 20c to which the developing bias is applied rotates in the clockwise direction in FIG. 2, in the developing region D, due to the potential difference between the developing bias and the bias of the exposed part of the photosensitive drum 1a, the toner carried on the surface of the developing sleeve 20c flies to the photosensitive drum 1a. The flying toner attaches, sequentially, to the exposed part on the photosensitive drum 1a that rotates in the direction indicated by arrow A (the counter-clockwise direction), and thereby the electrostatic latent image on the photosensitive drum 1a is developed.

Now, a stirring portion in the developing device will be described in detail with reference to FIG. 3. FIG. 3 is a sectional plan view (sectional view across line X-X′ in FIG. 2 as seen from the direction indicated by arrows X and X′) of the stirring portion of the developing device 3a.

In the developer container 22 are formed, as described above, the first conveyance chamber 22c, the second conveyance chamber 22d, the partition 22b, the upstream-side communication portion 22e, and the downstream-side communication portion 22f. In the developer container 22, there are further formed a developer supply port 22g, a developer discharge portion 22h, an upstream-side side wall portion 22i, and a downstream-side side wall portion 22j. With respect to the first conveyance chamber 22c, the left side in FIG. 3 is the upstream side, and the right side in FIG. 3 is the downstream side; with respect to the second conveyance chamber 22d, the right side in FIG. 3 is the upstream side, and the left side in FIG. 3 is the downstream side. Thus, the communication portions and the side wall portions are distinguished between the upstream-side and downstream-side ones relative to the second conveyance chamber 22d.

The partition 22b extends in the longitudinal direction of the developer container 22 to separate the first conveyance chamber 22c and the second conveyance chamber 22d parallel to each other. On one hand, the right-side end part of the partition 22b in the longitudinal direction forms the upstream-side communication portion 22e together with an inner wall part of the upstream-side side wall portion 22i. On the other hand, the left-side end part of the partition 22b in the longitudinal direction forms the downstream-side communication portion 22f together with an inner wall part of the downstream-side side wall portion 22j. Developer passes, sequentially, through the first conveyance chamber 22c, the upstream-side communication portion 22e, the second conveyance chamber 22d, and the downstream-side communication portion 22f to circulate through the developer container 22.

The developer supply port 22g is an opening through which fresh toner and carrier are supplied from the toner container 4a (see FIG. 1) provided over the developer container 22 into the developer container 22, and is arranged on the upstream side (the left side in FIG. 3) of the first conveyance chamber 22c.

The developer discharge portion 22h is a part through which developer that becomes surplus in the first and second conveyance chambers 22c and 22d as fresh toner and carrier are supplied is discharged, and is a pipe-shaped conveyance passage which is provided, in the shape of a cylinder, continuous with the second conveyance chamber 22d in the longitudinal direction on the downstream side of the second conveyance chamber 22d.

In the first conveyance chamber 22c, the first spiral 43 is arranged, and in the second conveyance chamber 22d, the second spiral 44 is arranged.

The first spiral 43 has a rotary shaft 43b and a first helical blade 43a which is provided integrally with the rotary shaft 43b and which is formed in a helical shape with a predetermined pitch in the axial direction of the rotary shaft 43b. The first helical blade 43a is provided to extend up to opposite end parts of the first conveyance chamber 22c in the longitudinal direction and to face the upstream-side and downstream-side communication portions 22e and 22f. The rotary shaft 43b is rotatably supported on the upstream-side side wall portion 22i and the downstream-side side wall portion 22j of the developer container 22.

The second spiral 44 has a rotary shaft 44b and a second helical blade 44a which is provided integrally with the rotary shaft 44b and which is formed in a helical shape spiraling in the opposite direction (opposite phase) to the first helical blade 43a with the same pitch as the first helical blade 43a in the axial direction of the rotary shaft 44b. The second helical blade 44a has a length equal to or larger than that of the magnetic roller 21 in the axial direction, and is provided so as to extend up to a position facing the upstream-side communication portion 22e. The rotary shaft 44b is arranged parallel to the rotary shaft 43b, and is rotatably supported on the upstream-side side wall portion 22i and the downstream-side side wall portion 22j of the developer container 22.

On the rotary shaft 44b, a decelerating-conveying portion 51, a regulating portion 52, and a discharge blade 53 are integrally arranged together with the second helical blade 44a.

The decelerating-conveying portion 51 is formed by a plurality of (here three) helical blades spiraling in the same direction as the second helical blade 44a. The helical blades constituting the decelerating-conveying portion 51 are configured to have the same outer diameter as, but a smaller pitch than, the second helical blade 44a.

The regulating portion 52 blocks the developer conveyed to the downstream side in the second conveyance chamber 22d and conveys developer in excess of a predetermined amount to the developer discharge portion 22h. The regulating portion 52 comprises a helical blade spiraling in the opposite direction (opposite phase) to the second helical blade 44a provided on the rotary shaft 44b, and is configured to have substantially the same outer diameter as, but a smaller pitch than, the second helical blade 44a. The regulating portion 52 forms a predetermined gap between an inner wall part of the developer container 22, such as the downstream-side side wall portion 22j, and an outer circumferential part of the regulating portion 52. The surplus developer is discharged through the gap.

On the rotary shaft 44b in the developer discharge portion 22h, the discharge blade 53 is provided. The discharge blade 53 comprises a helical blade spiraling in the same direction as the second helical blade 44a, and has a smaller pitch and a smaller circumference than those of the second helical blade 44a. Thus, as the rotary shaft 44b rotates, the discharge blade 53 also rotates so that the surplus developer conveyed over the regulating portion 52 into the developer discharge portion 22h is conveyed to the left side in FIG. 3 to be discharged out from the developer container 22. The discharge blade 53, the regulating portion 52, and the second helical blade 44a are molded integrally with the rotary shaft 44b out of synthetic resin.

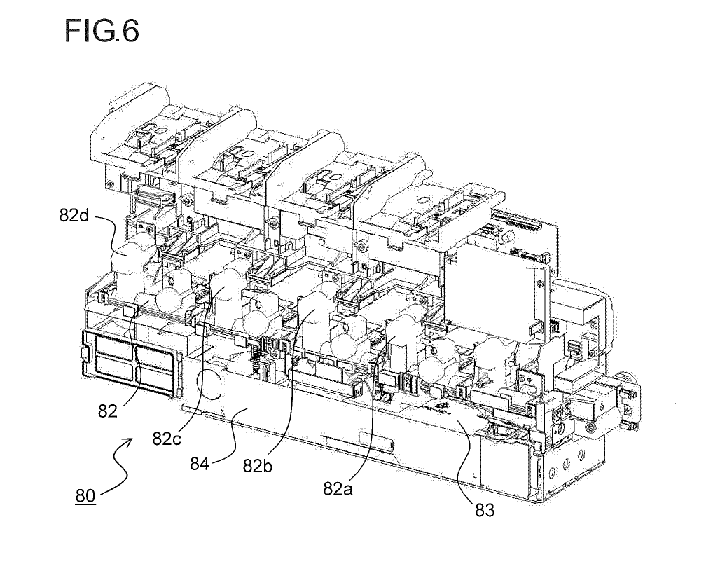

In a lower part of the developer discharge portion 22h, a discharge port 65 which communicates with coupling portions 82a to 82d (see FIG. 6) of a conveyance pipe 82 is formed, and to the outer circumferential surface of the developer discharge portion 22h, a shutter 70 which opens and closes the discharge port 65 is fitted.

On the outer wall of the developer container 22, gears 61 to 64 are arranged. The gears 61 and 62 are fixed on the rotary shaft 43b, the gear 64 is fixed on the rotary shaft 44b, and the gear 63 is rotatably held on the developer container 22 to mesh with the gears 62 and 64.

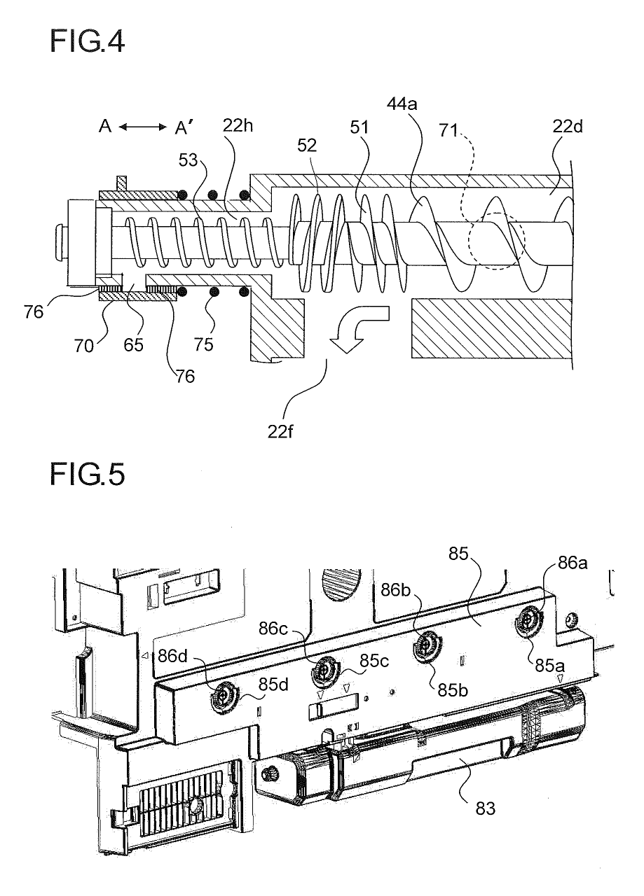

FIG. 4 is an enlarged view around the developer discharge portion 22h in FIG. 3. On the second spiral 44, the decelerating-conveying portion 51 is provided near the regulating portion 52 on its upstream side in the developer conveyance direction (the direction indicated by a white arrow in FIG. 4) so as to face the downstream-side communication portion 22f.

During development, during which no new developer is supplied, developer circulates through, while being stirred, the first conveyance chamber 22c, the upstream-side communication portion 22e, the second conveyance chamber 22d, and the downstream-side communication portion 22f, and the stirred developer is fed to the magnetic roller 21.

As toner is consumed in development, developer containing toner and carrier is supplied through the developer supply port 22g into the first conveyance chamber 22c. The supplied developer is, as during development, conveyed in the direction indicated by arrow P inside the first conveyance chamber 22c by the first helical blade 43a, and the developer is then conveyed through the upstream-side communication portion 22e into the second conveyance chamber 22d. Then, by the second helical blade 44a, the developer in the second conveyance chamber 22d is conveyed in the direction indicated by arrow Q to the decelerating-conveying portion 51. As the regulating portion 52 rotates together with the rotary shaft 44b, a conveying force in the direction opposite to the developer conveyance direction ascribable to the second helical blade 44a is applied to the developer by the regulating portion 52. The developer having its conveyance speed reduced through the decelerating-conveying portion 51 increases its height by being blocked near the decelerating-conveying portion 51 arranged on the upstream side of the regulating portion 52, and the surplus developer (substantially the same amount as the developer supplied through the developer supply port 22g) is discharged over the regulating portion 52 via the developer discharge portion 22h out of the developer container 22.

In the second conveyance chamber 22d, a toner concentration detection sensor 71 comprising a magnetic permeability sensor is arranged next to the decelerating-conveying portion 51 on its upstream side in the developer conveyance direction (the direction indicated by a hollow arrow in FIG. 4). On detecting the magnetic permeability of the developer, the toner concentration detection sensor 71 outputs to a control portion (unillustrated) a voltage value corresponding to the result of detection, and the control portion determines the toner concentration based on the output value of the toner concentration detection sensor 71.

The shutter 70 is a cylindrical member fitted around the developer discharge portion 22h so as to be slidable in the axial direction of the developer discharge portion 22h (the direction indicated by arrows A and A′). Between the shutter 70 and the developer container 22, a coil spring 75 is arranged. The shutter 70 is biased in the closing direction (the direction indicated by arrow A) by the coil spring 75. As shown in FIG. 4, the shutter 70 normally closes the discharge port 65 by being located at a position overlapping the discharge port 65 in the developer discharge portion 22h.

To the inner circumferential surface of the shutter 70, a sealing member 76 is fixed so as to prevent leakage of developer through a clearance between the outer circumferential surface of the developer discharge portion 22h and the shutter 70. The developer discharge portion 22h, the shutter 70, the coil spring 75, and the sealing member 76 constitute the developer conveying mechanism according to the present disclosure. The structure of the sealing member 76 will be described in detail later.

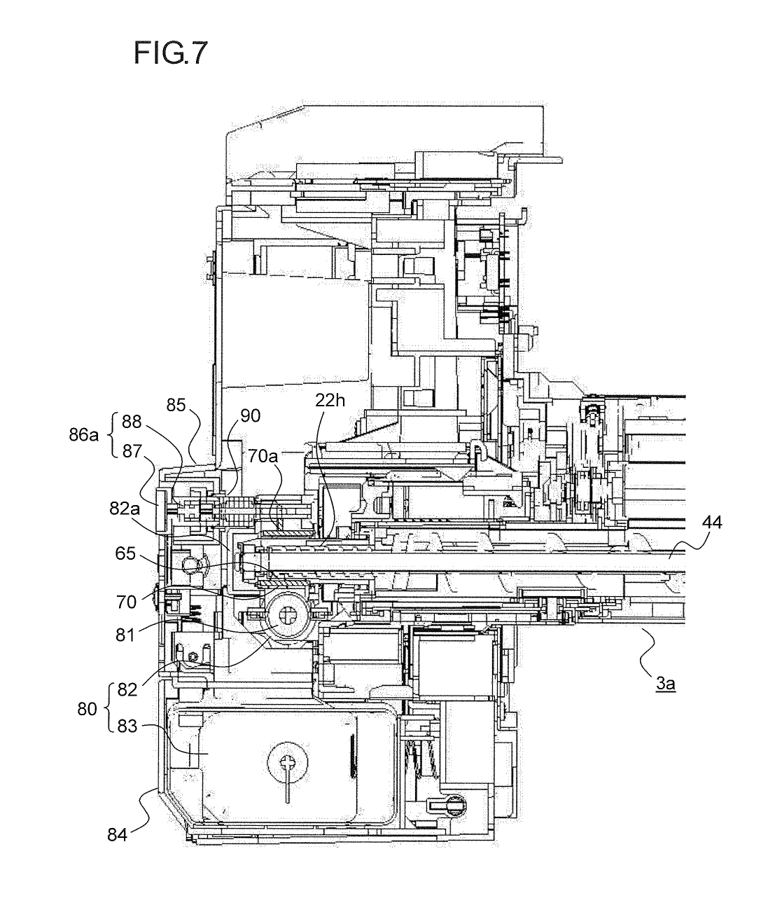

FIG. 5 is a partial perspective view showing a state with a front surface-side outer cover (unillustrated) of the color printer 100 open. FIG. 6 is a perspective view showing a state with the inner cover 85 in FIG. 5 removed to expose a developer collecting mechanism 80. FIG. 7 is a side sectional view of the developer collecting mechanism 80. In FIG. 6, the developing devices 3a to 3d are omitted from illustration. FIG. 7 shows a section of the developer collecting mechanism 80 at a position corresponding to the developing device 3a.

The developer collecting mechanism 80 includes the conveyance pipe 82 inside which a conveying screw 81 is arranged and a collection container 83 in which the developer conveyed via the conveyance pipe 82 is stored. The collection container 83 is housed in a retractable tray 84 (unillustrated in FIG. 5). On the conveyance pipe 82, the coupling portions 82a to 82d are formed which are coupled to the developer discharge portions 22h (see FIG. 4) of the developing devices 3a to 3d respectively.

At positions corresponding to the shutters 70 of the developing devices 3a to 3d, pressing members 86a to 86d are provided respectively. The pressing members 86a to 86d each have the shape of a screw having a head portion 87 and a shaft portion 88, and the shaft portion 88 penetrates the housing of the color printer 100 through a through hole 90 formed in it to be in contact with a protrusion 70a on the shutter 70. In the inner cover 85, window portions 85a to 85d are formed through which the head portions 87 of the pressing members 86a to 86d are exposed. The pressing members 86a to 86d are pressed in the direction of the inner cover 85 (the direction indicated by arrow A) by the shutter 70 biased by the coil spring 75 (see FIG. 4).

FIGS. 5 to 7 show states observed during the transportation (shipment) of the color printer 100, and when the developing device 3a is mounted in the color printer 100, as shown in FIG. 7, the discharge port 65 in the developer discharge portion 22h is closed by the shutter 70. Thus, even if the color printer 100 is transported in this state, there is no danger of the developer stored in the developing devices 3a to 3d leaking out through the discharge ports 65 due to shaking or an impact occurring during transportation.

When the color printer 100 is delivered to a user and is set up (with initial settings) by a serviceperson, with a screwdriver inserted into the head portion 87 of the pressing members 86a to 86d, these are pushed, while being rotated, into the inner cover 85. Here, the shaft portion 88 of the pressing members 86a to 86d and the through hole 90 have a key-keyhole relationship; thus, pushing the shaft portion 88 into the through hole 90 and then rotating the former through 90° permits the pressing members 86a to 86d to be fixed in a pushed-in position.

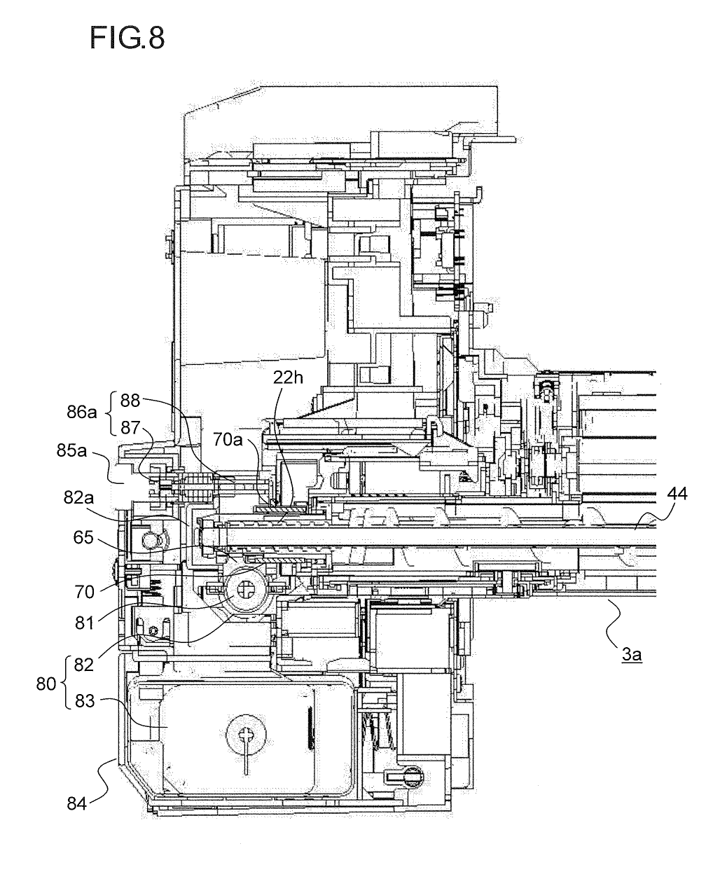

FIG. 8 is a side sectional view of the developer collecting mechanism 80 showing a state where the discharge port 65 is left open by the shutter 70. As the pressing members 86a to 86d are pushed into the inner cover 85, the shutter 70 is pushed by the shaft portion 88 of the pressing members 86a to 86d to move in the direction indicated by arrow A′ while compressing the coil spring 75 so as to open the discharge port 65. This permits the discharge port 65 in the developer discharge portion 22h and the conveyance pipe 82 to communicate with each other, and thus enables discharge of developer through the discharge port 65. The developer discharged through the discharge port 65 in the developer discharge portion 22h is conveyed through the conveyance pipe 82 by the conveying screw 81 to be stored in the collection container 83.

With the structure according to this embodiment, it is possible to reliably prevent, with a simple structure, contamination inside the color printer 100 resulting from leakage of developer from the developer discharge portion 22h occurring when the color printer 100 is transported (shipped) with developer stored in the developing devices 3a to 3d. At the time of set-up, it is possible to open the discharge port 65 with a simple operation.

Next, a description will be given of a relationship between the opening and closing operation of the shutter 70 and the sealing member 76 when the developing devices 3a to 3d are removed from the color printer 100. With a screwdriver inserted into the head portion 87 of the pressing members 86a to 86d, these are rotated through 90° in the direction opposite to that at the time of set-up; thereby, the pressing members 86a to 86d are pushed back toward the inner cover 85 by the restoring force of the compressed coil spring 75, and the shutter 70 moves in the direction indicated by arrow A to close the discharge port 65.

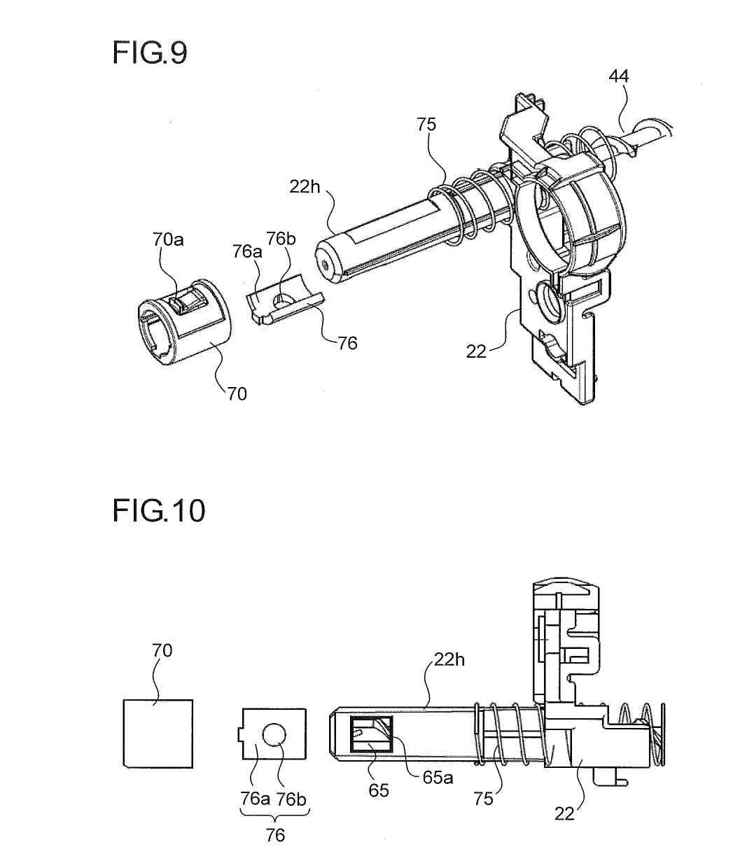

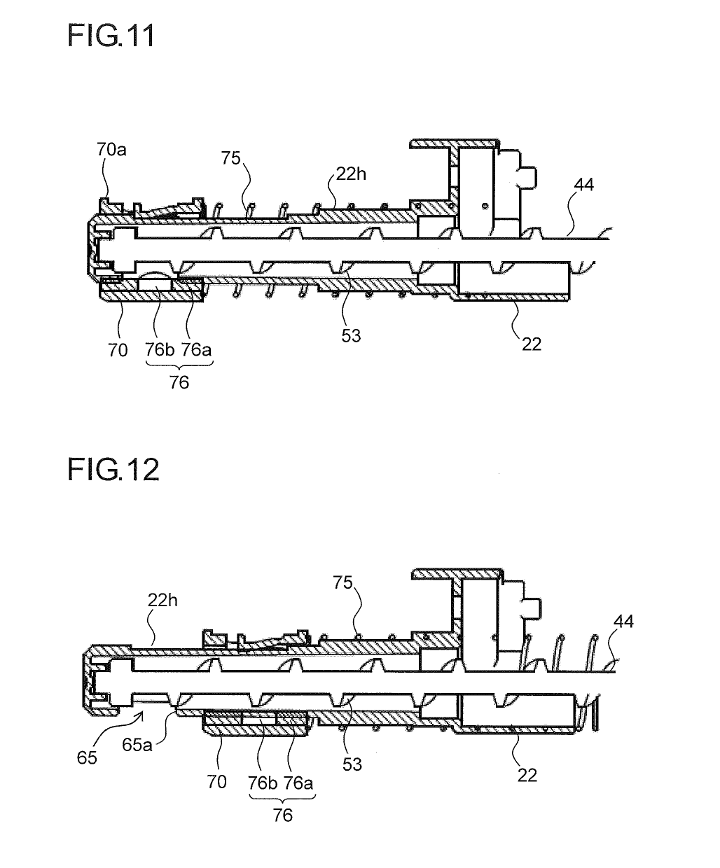

FIG. 9 is an exploded perspective view of the developer discharge portion 22h in the developing device 3a according to this embodiment. FIG. 10 is a plan view of the developer discharge portion 22h in FIG. 9 as seen from the discharge port 65 side (from below in FIG. 9). FIGS. 11 and 12 are side sectional views of the developer discharge portion 22h, respectively showing a state where the discharge port 65 is closed by the shutter 70 and a state where the discharge port 65 is left open by the shutter 70.

The shutter 70 is a cylindrical member fitted around the pipe-shaped developer discharge portion 22h, and on the outer circumferential surface of the shutter 70, the protrusion 70a is formed which is pressed by the shaft portion 88 (see FIG. 8) of the pressing members 86a to 86d (see FIG. 8).

The sealing member 76 is attached and fixed to the inner circumferential surface (the sliding surface with the developer discharge portion 22h) of the shutter 70. As the material of the sealing member 76, an elastic material such as sponge, nonwoven fabric, felt, nylon flock pile, or the like may be used. In this embodiment, a sealing member 76 made of sponge is fixed to the inner circumferential surface of the shutter 70 with double-sided adhesive tape.

Immediately before the shutter 70 closes the discharge port 65, the coil spring 75 (see FIG. 4) is about to return to its natural length from a compressed state. Thus, the restoring force (biasing force) of the coil spring 75 is weaker than immediately after the shutter 70 has started to move in the direction indicated by arrow A. Thus, if the sliding load (friction resistance) between the shutter 70 and the sealing member 76 increases as a result of developer attaching to the sealing member 76 or for some other cause, the shutter 70 does not completely close the discharge port 65; thus, removing the developing devices 3a to 3d in this state results in leakage of developer.

In this embodiment, the sealing member 76 is fixed to the sliding surface of the shutter 70. With this structure, when the developer discharge portion 22h is inserted into the coupling portion 82a (see FIG. 7) of the conveyance pipe 82, no developer attaches to the sealing member 76.

As a result, the sliding load does not increase due to the attachment of developer to the sealing member 76, and thus the shutter 70 does not stop its closing movement midway; this permits the shutter 70 to smoothly and reliably switch from the state (see FIG. 12) where the discharge port 65 is left open to the state (see FIG. 11) where the discharge port 65 is closed. Thus, it is possible to reliably prevent leakage of developer through the discharge port 65 resulting from the malfunction of the shutter 70.

The sliding load of the shutter 70 increases as the contact area between the developer discharge portion 22h and the sealing member 76 fixed to the shutter 70 increases. To cope with this, in this embodiment, the shape of the sealing member 76 is so designed as to reduce the sliding load of the shutter 70 more effectively to achieve both smooth operation of the shutter 70 and sufficient sealing.

Specifically, the sealing member 76 has a frame-shaped sealing portion 76a and a circular opening 76b formed in the sealing portion 76a. The sealing portion 76a makes contact with the outer circumferential surface of the developer discharge portion 22h so as to surround the discharge port 65 in the state where the discharge port 65 is closed by the shutter 70. Thus, the area of the sealing portion 76a (the contact area between the developer discharge portion 22h and the sealing member 76) is reduced by that of the opening 76b, and the sliding load of the shutter 70 is reduced accordingly.

Here, although an opening 76b smaller than the discharge port 65 is formed in the sealing member 76, there is no particular restriction on the size of the opening 76b; so long as the sealing member 76 (the sealing portion 76a) can seal around the discharge port 65 in the state where the discharge port 65 is closed by the shutter 70, an opening 76b larger than the discharge port 65 may be formed instead. However, the larger the opening 76b is, the smaller the area of the sealing portion 76a is; thus, while the sliding load between the developer discharge portion 22h and the sealing member 76 is reduced, the sealing performance is degraded and the attachment strength to the shutter 70 is reduced. Thus, it is necessary to form the opening 76b in an appropriate size with consideration given to the friction coefficient of the sealing member 76, the spring modulus of the coil spring 75 which permits the shutter 70 to slide, and the sealing performance, the attachment strength, and the like required in the sealing member 76.

Although there is no particular restriction on the shape of the opening 76b, with an opening 76b formed in a circular shape as in this embodiment, the outer circumferential rim of the opening 76b and an edge portion 65a of the discharge port 65 in a rectangular shape are unlikely to get caught on each other, and this helps prevent the malfunction of the shutter 70 and the coming off of the sealing member 76; it is thus preferable that the opening 76b be formed in a circular or oval shape.

When the opening 76b is formed in a rectangular shape, as shown in FIG. 13, the opening 76b is preferably formed in a rhombic shape. When the opening 76b is formed in a rhombic shape, four opening edges 77 all have predetermined angles relative to (are not parallel to) the edge portion 65a of the discharge port 65. This helps prevent the opening 76b in the sealing member 76 and the edge portion 65a from getting caught on each other when the shutter 70 closes.

The shape of the opening 76b is not limited to a rhombic shape, and may instead be a polygonal shape such as hexagonal or octagonal. Here, by forming the opening 76b in a polygonal shape such that all sides (opening edges) of the opening 76b have predetermined angles relative to the edge portion 65a of the discharge port 65, it is possible to prevent the opening 76b and the edge portion 65a from getting caught on each other as with the rhombic shape shown in FIG. 13.

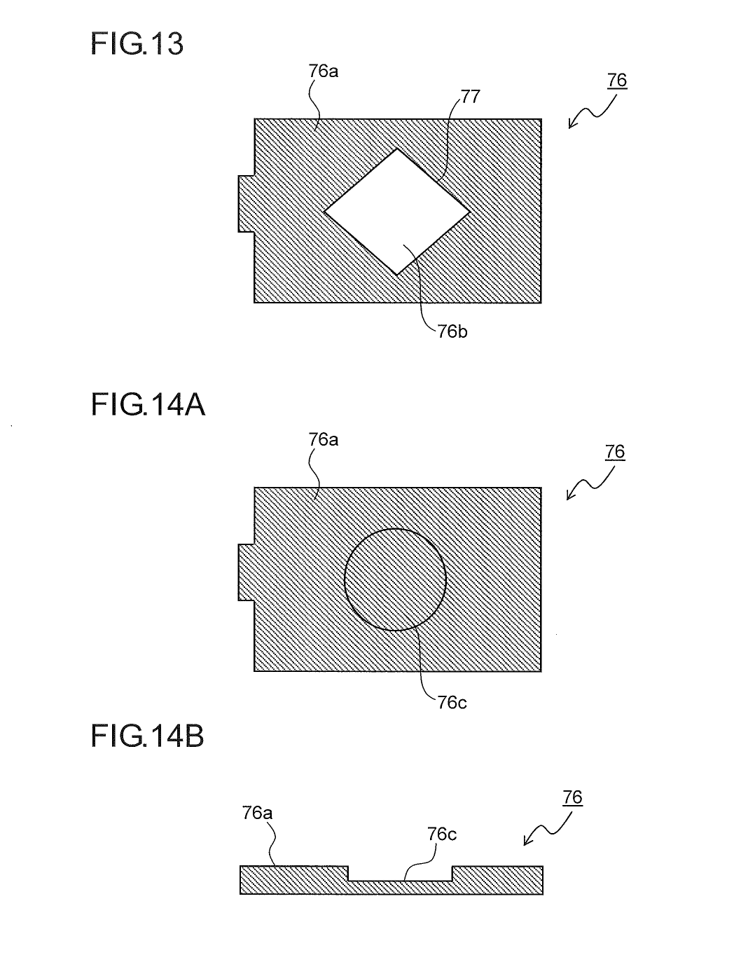

As shown in FIGS. 14A and 14B, instead of the opening 76b, a circular concavity 76c may be formed in the sealing member 76. Also with this design, as in the case where the opening 76b is formed, the area of the sealing portion 76a is reduced by that of the concavity 76c, and the sliding load of the shutter 70 can be reduced accordingly. The shape and size of the concavity 76c can be determined in a similar manner to the opening 76b.

The embodiments described above are in no way meant to limit the present disclosure, which thus allows for many modifications and variations within the spirit of the present disclosure. For example, the developer conveying mechanism according to the present disclosure is applicable, not only to a developer discharge portion in a developing device 3a, like the one shown in FIG. 2, which can be replenished with new two-component developer containing toner and carrier while discharging surplus developer, but also to various components which convey developer inside the image forming apparatus by use of a pipe-shaped passage. Incidentally, the “developer” conveyed by the developer conveying mechanism according to the present disclosure includes two-component developer containing toner and magnetic carrier, one-component developer containing toner alone, waste toner having been fed to an image carrying member out of two-component developer and then collected from the image carrying member, and the like.

For example, the present disclosure is applicable also to a case where, in a developer conveying mechanism that conveys waste toner removed from the photosensitive drums 1a to 1d by the cleaning devices 7a to 7d in FIG. 1 and waste toner removed from the intermediate transfer belt 8 by the belt cleaner 19 to a waste toner collection container by use of a pipe-shaped passage and a conveying screw, the developer conveying mechanism is removably inserted in the color printer 100, and a shutter which opens and closes a discharge port in the pipe-shaped passage is provided to prevent leakage of waste toner.

The present disclosure is applicable, not only to tandem-type color printers like the one shown in FIG. 1, but also to various image forming apparatuses such as digital and analog monochrome copiers, color copiers, facsimile machines, and the like.

The present disclosure finds application in developer conveying mechanisms incorporated in image forming apparatuses utilizing electrophotography, such as copiers, printers, facsimile machines, and multifunction peripherals having their functions integrated together. Based on the present disclosure, it is possible to provide a developer conveying mechanism that can reliably prevent leakage of developer through a developer discharge port formed in a passage through which developer is conveyed and that allows smooth operation of a shutter which opens and closes the developer discharge port.

What is claimed is:

1. A developer conveying mechanism comprising:
a pipe-shaped conveyance passage through which developer is conveyed, the pipe-shaped conveyance passage having a discharge port formed in a part of a side surface thereof;
a shutter arranged so as to be slidable along an outer circumferential surface of the pipe-shaped conveyance passage, the shutter opening and closing the discharge port;
a sealing member fixed to an inner circumferential surface of the shutter; and
a biasing member biasing the shutter in a direction in which the discharge port is closed, wherein
the sealing member has a contact portion which makes contact with the outer circumferential surface of the pipe-shaped conveyance passage so as to surround the discharge port in a state where the discharge port is closed by the shutter, and a non-contact portion in the contact portion.

2. The developer conveying mechanism of claim 1, wherein
the discharge port has a rectangular shape, and the non-contact portion has a circular or oval shape in a plan view.

3. The developer conveying mechanism of claim 1, wherein
the discharge port has a rectangular shape, and the non-contact portion has a polygonal shape in a plan view such that all sides of the non-contact portion have predetermined angles relative to an edge portion of the discharge port in opening and closing directions of the shutter.

4. The developer conveying mechanism of claim 1, wherein
the non-contact portion is an opening or a concavity.

5. A developing device comprising:
a developer container in which two-component developer containing carrier and toner is stored;
a developer supply port through which developer is supplied into the developer container; and
a developer discharge portion through which surplus developer is discharged out of the developer container, wherein
as the developer discharge portion, the developer conveying mechanism of claim 1 is used.

6. An image forming apparatus comprising the developer conveying mechanism of claim 1.

7. An image forming apparatus comprising the developing device of claim 5.
